(19) United States
(12) Patent Application Publication
(10) Pub. No.: US 2012/0035945 A1
(43) Pub. Date: Feb. 9, 2012

(54) SYSTEMS AND METHODS TO COMPUTE OPERATION METRICS FOR PATIENT AND EXAM WORKFLOW

(75) Inventors: Nikhil Jain, Barrington, IL (US); Atulkishen Setlur, Barrington, IL (US); Kengo Baba, Evanston, IL (US); Tushad Driver, Barrington, IL (US); Ashish Vassa, Palatine, IL (US); Vadim Berezhanskiy, Barrington, IL (US); Piyush Raizada, Barrington, IL (US)

(73) Assignee: GENERAL ELECTRIC COMPANY, Schenectady, NY (US)

(21) Appl. No.: 12/853,088

(22) Filed: Aug. 9, 2010

(51) Int. Cl. G06Q 10/00; G06Q 50/00

(52) U.S. Cl. 705/2

(57) ABSTRACT

An example operation metrics collection and processing system is to mine a data set including patient and exam workflow data from information source(s) according to an operational metric for a workflow of interest; identify one or more states involved in the workflow; determine a wait time for each of the state(s); apply one or more applicable deductions to the wait time for each of the state(s) based on one or more workflow-specific events to generate an adjusted wait time for each of the state(s) in the workflow of interest; aggregate the adjusted wait time for each of the state(s) to generate a normalized wait time for the workflow of interest; group normalized wait times for the workflow of interest according to one or more thresholds; and output a representation of the normalized wait times to the user interface based on the grouping and the one or more thresholds.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD

The presently described technology generally relates to systems and methods to determine performance indicators in a workflow in a healthcare enterprise. More particularly, the presently described technology relates to computing operation metrics for patient and exam workflow.

### BACKGROUND

Most healthcare enterprises and institutions perform data gathering and reporting manually. Many computerized systems house data and statistics that are accumulated but have to be extracted manually and analyzed after the fact. These approaches suffer from “rear-view mirror syndrome”—by the time the data is collected, analyzed, and ready for review, the institutional makeup in terms of resources, patient distribution, and assets has changed. Regulatory pressures on healthcare continue to increase. Similarly, scrutiny over patient care increases.

Pioneering healthcare organizations such as Kaiser Permanente, challenged with improving productivity and care delivery quality, have begun to define Key Performance Indicators (KPI) or metrics to quantify, monitor and benchmark operational performance targets in areas where the organization is seeking transformation. By aligning departmental and facility KPIs to overall health system KPIs, everyone in the organization can work toward the goals established by the organization.

### BRIEF SUMMARY

Certain examples provide systems and methods for collection and processing of clinical data to generate one or more performance indicators and/or other operation metrics.

Certain examples provide a computer-implemented method for generating operational metrics for a healthcare workflow. The method includes mining a clinical data set including patient and exam workflow data according to an operational metric for a workflow of interest. The method includes identifying one or more states involved in the workflow of interest. The method includes determining a wait time for each of the one or more states. The method also includes applying one or more applicable deductions to the wait time for each of the one or more states based on one or more workflow-specific events to generate an adjusted wait time for each of the one or more states in the workflow of interest. Additionally, the method includes aggregating the adjusted wait time for each of the one or more states to generate a normalized wait time for the workflow of interest. The method includes grouping normalized wait times for the workflow of interest according to one or more thresholds. The method also includes outputting a representation of the normalized wait times based on the grouping and the one or more thresholds.

Certain examples provide a tangible computer-readable storage medium having a set of instructions stored thereon which, when executed, instruct a processor to implement a method for generating operational metrics for a healthcare workflow. The method includes mining a clinical data set including patient and exam workflow data according to an operational metric for a workflow of interest. The method includes identifying one or more states involved in the workflow of interest. The method includes determining a wait time for each of the one or more states. The method also includes applying one or more applicable deductions to the wait time for each of the one or more states based on one or more workflow-specific events to generate an adjusted wait time for each of the one or more states in the workflow of interest. Additionally, the method includes aggregating the adjusted wait time for each of the one or more states to generate a normalized wait time for the workflow of interest. The method includes grouping normalized wait times for the workflow of interest according to one or more thresholds. The method also includes outputting a representation of the normalized wait times based on the grouping and the one or more thresholds.

Certain examples provide an operation metrics collection and processing system. The system includes a memory, a processor, and a user interface to display a dashboard including one or more performance indicators for review. The processor executes instructions saved on the memory to: mine a clinical data set including patient and exam workflow data from one or more information sources according to an operational metric for a workflow of interest; identify one or more states involved in the workflow of interest; determine a wait time for each of the one or more states; apply one or more applicable deductions to the wait time for each of the one or more states based on one or more workflow-specific events to generate an adjusted wait time for each of the one or more states in the workflow of interest; aggregate the adjusted wait time for each of the one or more states to generate a normalized wait time for the workflow of interest; group normalized wait times for the workflow of interest according to one or more thresholds; and output a representation of the normalized wait times to the user interface based on the grouping and the one or more thresholds.

### BRIEF DESCRIPTION OF SEVERAL VIEWS OF THE DRAWINGS

FIG. 1 depicts an example healthcare information enterprise system to measure, output, and improve operational performance metrics.

FIG. 2 illustrates an example healthcare information enterprise system to measure, output, and improve operational performance metrics.

FIG. 3 illustrates an example dashboard interface to facilitate viewing of and interaction with KPI information, alerts, and other data.

FIG. 4 depicts an example detail patient grid providing patient information and worklist data for a clinician, department, and/or institution, etc.

FIG. 5 depicts a flow diagram for an example method 500 for computation and output of operational metrics for patient and exam workflow.

FIG. 6 is a block diagram of an example processor system that may be used to implement the systems, apparatus and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples provide systems and methods to determine operational metrics or key performance indicators (KPIs) such as patient wait time. Certain examples facilitate a more accurate calculation of patient wait time and/or other metric/indicator with a multiple number of patient workflow events to accommodate variation of workflow.

Hospital administrators should be able to quantify an amount of time a patient is waiting during a radiology workflow, for example, where the patient is prepared and transferred to obtain radiology examination by scanners such as magnetic resonance (MR) and/or computed tomography (CT) imaging systems. A more accurate quantification of patient wait time helps to improve patient care and optimize or improve radiology and/or other healthcare department/enterprise operation.

Many hospital information systems provide information regarding events and/or actions taken for a patient. A patient workflow varies in many ways depending on factors such as exam procedure, particular department practice, patient condition, etc. More accurate quantification of the actual time a patient is waiting for a next pending action is complicated due to many workflow variations.

Certain examples help provide an understanding of the real-time operational effectiveness of an enterprise and help enable an operator to address deficiencies. Certain examples thus provide an ability to collect, analyze and review operational data from a healthcare enterprise in real time or substantially in real time given inherent processing, storage, and/or transmission delay. The data is provided in a digestible manner adjusted for factors that may artificially affect the value of the operational data (e.g., patient wait time) so that an appropriate responsive action may be taken.

KPIs are used by hospitals and other healthcare enterprises to measure operational performance and evaluate a patient experience. KPIs can help healthcare institutions, clinicians, and staff provide better patient care, improve department and enterprise efficiencies, and reduce the overall cost of delivery. Compiling information into KPIs can be time consuming and involve administrators and/or clinical analysts generating individual reports on disparate information systems and manually aggregating this data into meaningful information.

KPIs represent performance metrics that can be standard for an industry or business but also can include metrics that are specific to an institution or location. These metrics are used and presented to users to measure and demonstrate performance of departments, systems, and/or individuals. KPIs include, but are not limited to, patient wait times (PWT), turn around time (TAT) on a report or dictation, stroke report turn around time (S-RTAT), or overall film usage in a radiology department. For dictation, a time can be a measure of time from completed to dictated, time from dictated to transcribed, and/or time from transcribed to signed, for example.

In certain examples, data is aggregated from disparate information systems within a hospital or department environment. A KPI can be created from the aggregated data and presented to a user on a Web-enabled device or other information portal/interface. In addition, alerts and/or early warnings can be provided based on the data so that personnel can take action before patient experience issues worsen.

For example, KPIs can be highlighted and associated with actions in response to various conditions, such as, but not limited to, long patient wait times, a modality that is underutilized, a report for stroke, a performance metric that is not meeting hospital guidelines, or a referring physician that is continuously requesting films when exams are available electronically through a hospital portal. Performance indicators addressing specific areas of performance can be acted upon in real time (or substantially real time accounting for processing, storage/retrieval, and/or transmission delay), for example.

In certain examples, data is collected and analyzed to be presented in a graphical dashboard including visual indicators representing KPIs, underlying data, and/or associated functions for a user. Information can be provided to help enable a user to become proactive rather than reactive. Additionally, information can be processed to provide more accurate indicators accounting for factors and delays beyond the control of the patient, the clinician, and/or the clinical enterprise. In some examples, “inherent” delays can be highlighted as separate actionable items apart from an associated operational metric, such as patient wait time.

Certain examples provide configurable KPI (e.g., operational metric) computations in a work flow of a healthcare enterprise. The computations allow KPI consumers to select a set of relevant qualifiers to determine a scope of a data countable in the operational metrics. An algorithm supports the KPI computations in complex work flow scenarios including various work flow exceptions and repetitions in an ascending or descending work flow statuses change order (such as, exam or patient visit cancellations, re-scheduling, etc.), as well as in scenarios of multi-day and multi-order patient visits, for example.

KPI qualifiers and input options include, but are not limited to, the following:

a) Configurable time range(s);

b) A combination of configurable workflow initial and final states and events with selectable state existence conditions such as “any”, “all”, “none”;

c) Any relationship database management system (RDBMS) vendor-supported data aggregation function(s), such as “minimum”, “maximum”, “average”, “count”, “sum”, etc., that are being used in computations.

d) An ability to apply configurable wait time deduction for a specific workflow condition(s) as defined by the consumer;

e) An ability to apply configurable business hours adjustment(s) as defined by the consumer;

f) Configurable operational metric threshold condition(s) to group a relevant data; and/or

g) An ability to filter and group data by relevant work flow dimension(s) including but not limited to radiological/cardiological procedures and groups of procedures, digital modalities, hospital facilities, patient classes and types, admission types, order priorities, healthcare enterprise departments, referral physicians and services, inpatient locations, etc.

Certain examples provide a process to solve patient wait time and/or turn-around time. The method first mines a data set at an exam and a visit level within a specified time range based on initial and final states of patient visit and exam workflow. This data set includes date and time stamps for events of interest in a hospital workflow along with exam and patient attributes specified by standards/protocols, such as HL7/DICOM standards.

A user can specify whether any or all states have or have not been reached. The user also has an ability to pass relevant filter(s) that are specific to a hospital workflow. A result data set is built dynamically based on the user conditions.

Among events that bear a certain time stamp, certain events have different start and end times for which the end time may have not been communicated by any digital system. Thus, a system can include a capability to configure the completion time of that event.

As an example, patient preparation is a single event in patient workflow for which the start of event is communicated digitally but the end of event is not communicated. It becomes important to account for the time spent during that event and add it to a start event data time so that time spent in the activity is accounted for. The wait time can be computed with such deductions. For example, the patient was administered medicine for a nuclear CT with contrast procedure during patient preparation at 1:30 PM, and the CT scan was conducted at 2:00 PM. Based on this information, a tracking or timing system or associated metric should not show that patient is waiting idle for thirty (30) minutes if it takes thirty (30) minutes for the drug to take effect, for example.

Certain examples automatically identify and/or monitor, with manual user intervention, hospital workflow specific events during single patient visit. These events can include, for example, multiple exams in single patient visit, laboratory orders, pharmacy orders, patient transportation within a hospital, and/or other user defined hospital workflow events of interest. A search is then performed followed by a sort of results based on events of interest. The patient wait time between different events within single visit is computed.

In certain examples, pre-configurable business hours adjustments can be applied to compute wait times for a state and event within a hospital workflow. For example, a business hours computation can be important, as many hospitals do not provide certain services during the night. Therefore, since services are not available to be provided, after business hours time can be deducted from wait time computations.

In certain examples, a KPI process excludes or includes an exam and/or visit according to its rollback status and ignores the states which are rolled back. Canceled visits and/or exams are also excluded.

Multiple exams during a single patient visit can be linked based on visit identifier, date, and/or modality, for example. The patient is not counted multiple times for wait time calculation purposes. Additionally, all associated exams are not marked as dictated when an event associated with dictation of one of the exams is received.

After adjustments have been made, a KPI process performs a requested aggregation on the resulting data set. For example, if a final condition is not reached, a maximum time stamp is calculated for an initial condition and is deducted from the current time to determine the wait time. If a final condition is reached, the process calculates a maximum time stamp of an initial condition and a minimum time stamp for a final condition to calculate the elapse time.

Once the above computations are completed, visits and exams are grouped according to one or more time threshold(s) as specified by one or more users in a hospital or other monitored healthcare enterprise. For example, an emergency department in a hospital wants to divide the patient wait times during visits into 0-15 minute, 15-30 minute, and over 30 minute wait time groups.

Once data can be grouped in terms of absolute numbers or percentages, it can be presented to a user. The data can be presented in the form of various graphical charts such as traffic lights, bar charts, and/or other graphical and/or alphanumeric indicators based on threshold(s), etc.

Thus, certain examples help facilitate operational data-driven decision-making and process improvements. To help improve operational productivity, tools are provided to measure and display a real-time (or substantially real-time) view of day-to-day operations. In order to better manage an organization's long-term strategy, administrators are provided with simpler-to-use data analysis tools to identify areas for improvement and monitor the impact of change. For example, imaging departments are facing challenges around reimbursement. Certain examples provide tool to help improve departmental operations and streamline reimbursement documentation, support, and processing.

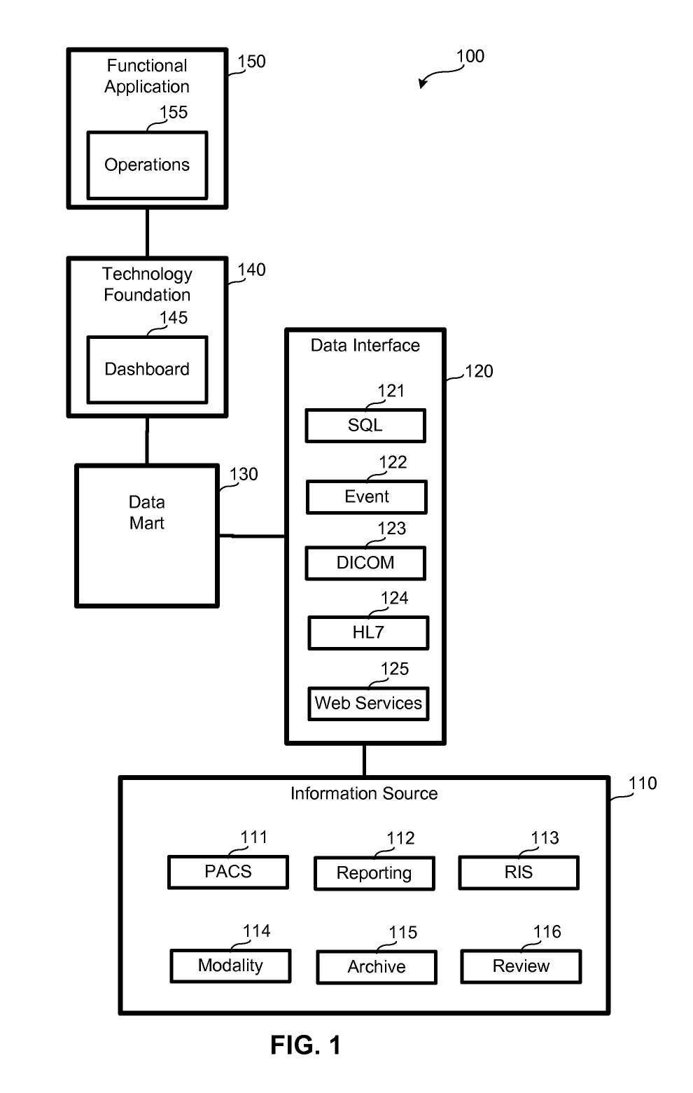

FIG. 1 depicts an example healthcare information enterprise system 100 to measure, output, and improve operational performance metrics. The system 100 includes a plurality of information sources, a dashboard, and operational functional applications. More specifically, the example system 100 shown in FIG. 1 includes a plurality of information sources 110 including, for example, a picture archiving and communication system (PACS) 111, a precision reporting subsystem 112, a radiology information system (RIS) 113 (including data management, scheduling, etc.), a modality 114, an archive 115, a modality 116, and a quality review subsystem 116 (e.g., PeerVue™)

The plurality of information sources 110 provide data to a data interface 120. The data interface 120 can include a plurality of data interfaces for communicating, formatting, and/or otherwise providing data from the information sources 110 to a data mart 130. For example, the data interface 120 can include one or more of an SQL data interface 121, an event-based data interface 122, a DICOM data interface 123, an HL7 data interface 124, and a web services data interface 125.

The data mart 130 receives and stores data from the information source(s) 110 via the interface 120. The data can be stored in a relational database and/or according to another organization, for example. The data mart 130 provides data to a technology foundation 140 including a dashboard 145. The technology foundation 140 can interact with one or more functional applications 150 based on data from the data mart 130 and analytics from the dashboard 145, for example. Functional applications can include operations applications 155, for example.

As will be discussed further below, the dashboard 145 includes a central workflow view and information regarding KPIs and associated measurements and alerts, for example. The operations applications 155 include information and actions related to equipment utilization, wait time, report read time, number of cases read, etc.

KPIs reflect the strategic objectives of the organization. Examples in Radiology include but are not limited to reduction in patient wait times, improving exam throughput, reducing dictation and report turn-around times, and increasing equipment utilization rate. KPIs are used to assess the present state of the organization, department or the individual and to provide actionable information with a clear course of action. They assist a healthcare organization to measure progress towards the goals and objectives established for success. Departmental managers and other front-line staff, however, find it difficult to pro-actively manage to these KPIs in real-time. This is at least partly because the data to build KPIs resides in disparate information sources and should be correlated to compute KPI performance.

A KPI can accommodate, but is not limited to, the following workflow scenarios:

1. Patient wait times until an exam is started.

2. Turn-around times between any hospital workflow states.

3. Add or remove multiple exam/patient states from KPI computations. For example, some hospitals wish to add multiple lab states in a patient workflow, and KPI computations can account for these states in the calculations.

4. Canceled visits and exams should automatically be excluded from computations.

5. Multiple exams in single patient visit during single day should be distinguished from single patient wait time versus single patient same exam during multiple days.

6. Wait time deductions should be applied where drugs are administered and drugs take time to come into affect.

7. Off business hours should be excluded from turn around and/or wait times of different events.

8. Exam should be allowed to roll back into any previous state and should be excluded or included in KPI calculations accordingly.

9. A user should have options to configure KPI according to hospital needs/wants/preferences, and KPI should perform calculations according to user configurations.

10. Multiple exams should be linked to single exams if the exams are from a single visit, same modality, same patient, and same day, for example.

Using KPI computation(s) and associated support, a hospital and/or other healthcare administrator can obtain more accurate information of patient wait time and/or turn-around time between different workflow states in order to optimize or improve operation to provide better patient care.

Even if a patient workflow involves an alternate workflow, the application can obtain multiple workflow events to process a more accurate patient wait time. Calculation of patient wait time or turn-around time between different workflow states can be configured and adjusted for different workflow and procedures.

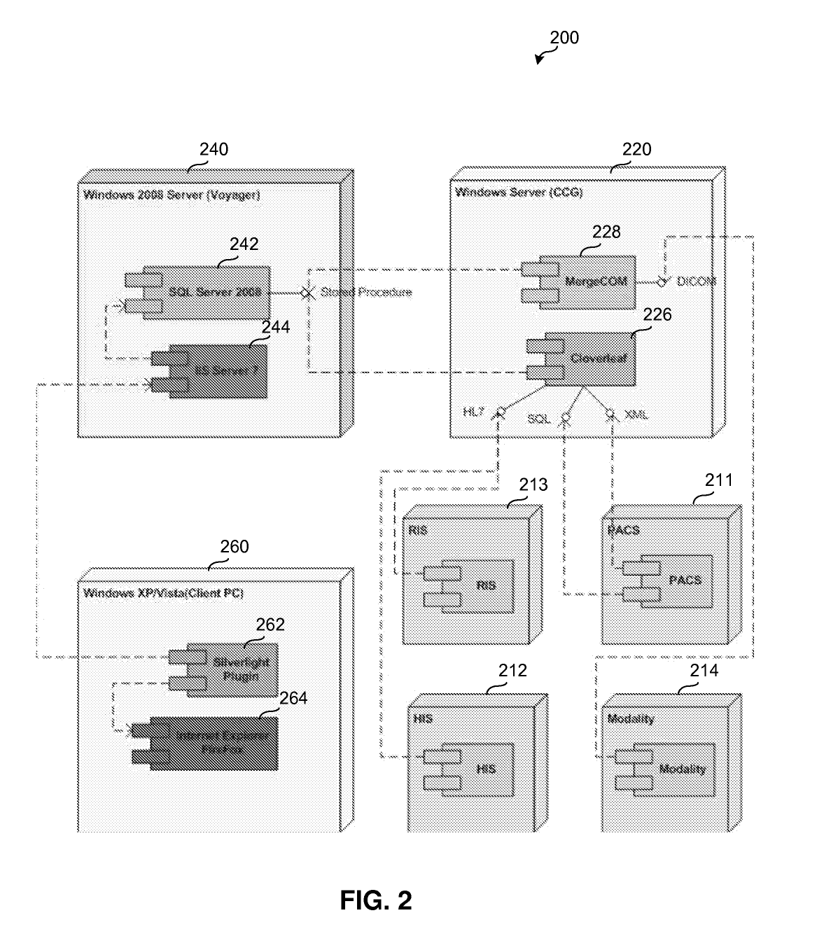

FIG. 2 illustrates an example healthcare information enterprise system 200 to measure, output, and improve operational performance metrics. The system 200 includes a plurality of information systems, such as a PACS 211, a hospital information system (HIS) 212, a RIS 213, and/or a modality 214. The information systems communicate, e.g., via HL7, SQL, DICOM, and/or other format/protocol with an interface 220. The interface 220 can be a Microsoft Windows™ Server including an interface engine 226 (e.g., a Cloverleaf™ HL7 translation, mapping, and routing interface engine) and an information exchange toolkit 228 (e.g., a MergeCOM™ DICOM connectivity toolkit). The interface 220 routes data from the information systems 211-214 to an operations dashboard server 240. The server 240 can be a Microsoft Windows™ server including a Structured Query Language (SQL) server 242 and an Internet Information Server (IIS) server 244. Using the SQL server 242 and the IIS server 244, an operational metrics dashboard can be provided to a user workstation 260. The dashboard can be implemented a Web-based interactive dashboard using a content development platform 262 (e.g., a Microsoft Silverlight™ plug-in) and a browser 264 (e.g., Microsoft Internet Explorer™ or Mozilla Firefox™)

A patient has to wait at many points in a healthcare workflow. It is difficult to gauge accurately the time the patient spent waiting for an activity to begin when it could have. It is expected that the next activity begin immediately after the prior one is finished. However, a wait may be required by the workflow itself. For example, a patient may have to wait for some time for a contrast to take effect before a scan is performed. This portion of time is not considered as patient wait time and should be removed from wait time calculations.

Certain example processes and associated systems described herein allow a customer to provide wait time deductions from wait time metrics based on one or more identified parameters or constraints. As a result, the customer receives a normalized wait time picture of the departmental workflow regardless of the procedure that was performed. For example, patient wait time can be determined by calculating the time difference between two defined workflow states and applying the applicable wait time deductions. This works well in situations where information on every single step within a workflow activity is not available, for example.

Alternatively or in addition, activities and sub-activities within a workflow can be tracked, and parallelism within the activities and within the sub-activities can be identified. The time between an end of a previous activity and a beginning of a next activity (e.g., patient wait time) can then be calculated based on this information. Patient wait times can be added to arrive at a total patient wait time. While this approach is possible, it may not be preferred because, in a healthcare departmental setting, numerous systems may track limited portions of the workflow but do not necessarily share that information.

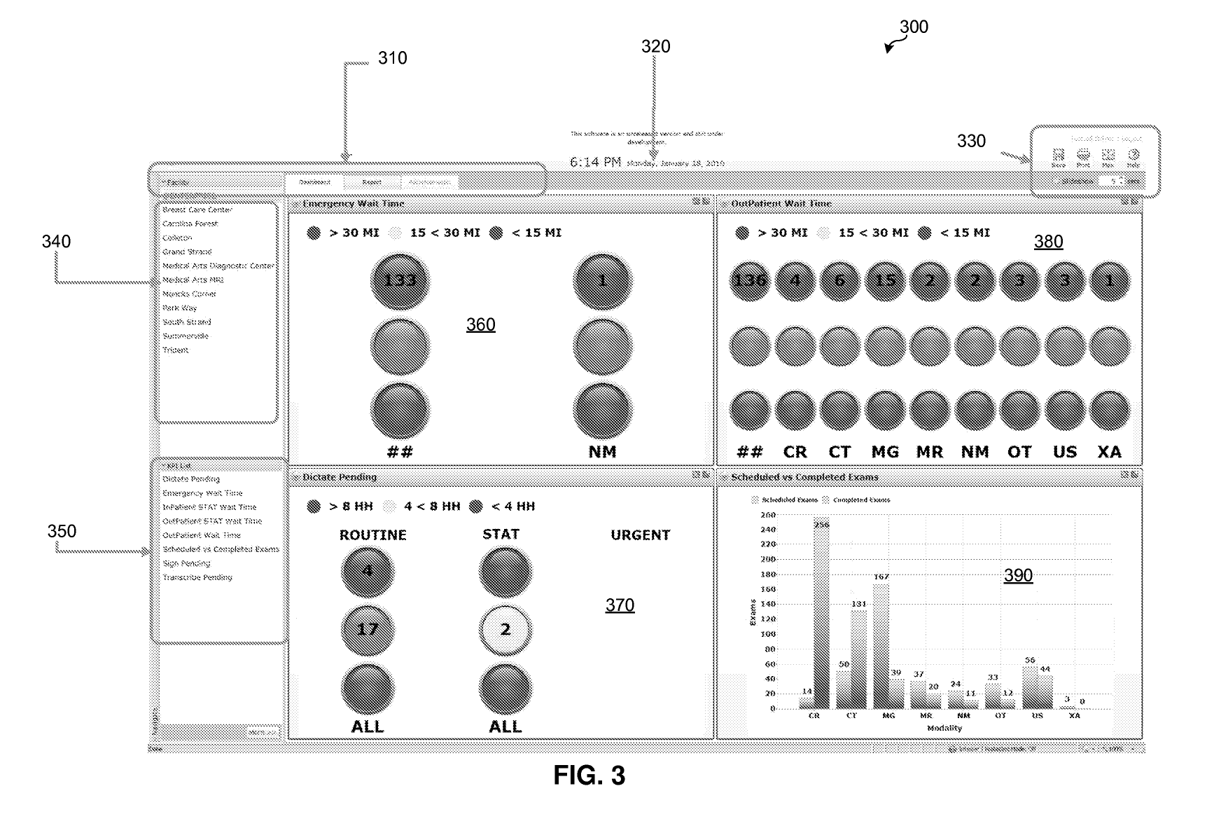

FIG. 3 illustrates an example dashboard interface 300 to facilitate viewing of and interaction with KPI information, alerts, and other data. The dashboard 300 provides a real-time (or at least substantially real-time) view of radiology and/or other department and/or enterprise operations tailored to administrator, technologist, wait areas, and/or other criteria, etc. The dashboard 300 helps facilitate pro-active management via visual and off-line alert and helps to streamline communication. The dashboard can be Web-based and/or accessible via other software application on a user's computer, for example.

The dashboard 300 can help provide seamless (or relatively seamless) access to workflow status, for example. The dashboard 300 can receive data from a robust correlation engine that aggregates workflow events from a variety of sources including a modality, PACS, RIS, virtual radiography (VR), labs, pharmacy/pharmaceutical, scheduling, computerized physician order entry (CPOE). The dashboard 300 can provide facility level data segregation (e.g., views, multi-RIS, etc.). In certain examples, the dashboard 300 presents collected information and allows a user to view and drill down to further levels of detail regarding the information. The dashboard 300 can be configurable based on institution, department, user, etc.

For example, at an enterprise level, users can monitor financial data from billing and cost tracking systems, average census information, number of admissions and discharges, and length of stay. At a departmental level, users can monitor patient wait times, average number of exams performed, types of exams performed, dictation and report turn-around times, and employee utilization. At an individual level, performance of staff, equipment and support systems, as well as overall patient, physician and employee satisfaction, can be monitored. In certain examples, the dashboard 300 can be a part of an Internet web site or system to facilitate collaboration and exchange of KPIs and related data among an online community.

Additionally, the dashboard 300 can help facilitate ongoing performance improvement for a healthcare facility. For example, a custom workflow definition can be developed to more accurately represent cross-departmental workflow and customize facility-specific process metrics. A monthly outlier report can help capture reason(s) for delay.

The example dashboard 300 includes a tab control 310 to facilitate user navigation between modules in the dashboard (e.g., dashboard, report, administration, etc.). The dashboard 300 also includes a header 320 to provide identification information such as time, date, user, role, etc. The dashboard 300 includes one or more convenience controls 330 to allow a user to quickly access and execute certain functionality such as save KPI, print KPI, expand KPI, help, slide show, etc.

The dashboard 300 includes a tree control 340 to facilitate navigation through healthcare facilities in a particular region or market. For example, the navigation control 340 can include a plurality of facilities in a region or common ownership structure and allow a user to select one or more of the regions to display KPIs and/or other information associated with the selected facility(ies).

The dashboard 300 also includes a KPI selection control 350. One or more KPIs 360, 370, 380, 390 are displayed in more detail via the dashboard 300 based on one or more of default settings, user preferences, and/or selections via the KPI selection control 350. For example, a user can select one or more KPIs for which information has been collected and processed including but not limited to dictation pending, emergency wait time, in-patient STAT wait time, out-patient wait time, scheduled versus completed exams, signature pending, and/or transcription pending, etc.

As shown, for example, in FIG. 3, an emergency wait time KPI 360 is depicted using a visual “traffic light” representation of KPI data and associated alerts. Visual cues provide an indication of how many patients have been waiting less than fifteen minutes (green), between fifteen and thirty minutes (yellow), and more than thirty minutes (red) (e.g., one shown in the example dashboard 300) for a computed tomography (CT) or computed radiography (CR) exam. Thus, the circles in the KPI box 360 are lights that show the status of that indicator based upon one or more pre-determined parameters (e.g., green for good, yellow or amber for caution or possible problems, and red for an alert condition or existence of a significant problem). In certain examples, by selecting one of the circles, additional information regarding the associated data and metric/parameter used to analyze it can be displayed to the user. Other visual and/or alphanumeric alert indicators can be used instead of or in addition to the traffic light indicators shown in FIG. 3.

As shown, for example, in FIG. 3, a dictation pending KPI 370 is also depicted using a visual traffic light representation of KPI data and associated alerts. Visual cues provide an indication of how many exams have been sitting in a queue for less than four hours (green), between four and eight hours (yellow), and more than eight hours (red) to be reviewed and have results dictated. In the example of FIG. 3, four routine exams have been waiting for more than eight hours; seventeen routine and two stat exams have been waiting between four and eight hours; and no exams have been waiting in the queue for less than four hours.

As shown, for example, in FIG. 3, an outpatient wait time KPI 380 is depicted using a visual traffic light representation of KPI data and associated alerts. Visual cues provide an indication of how many outpatients have waiting to be seen for less than fifteen minutes (green), between fifteen and thirty minutes (yellow), and more than thirty minutes (red). In the example of FIG. 3, several patients have been waiting for more than thirty minutes for a variety of services, such as CR, CT, mammography (MG), MR, nuclear medicine (NM), other (OT), ultrasound (US), and/or X-ray angiography (XA).

As shown, for example, in FIG. 3, a scheduled versus completed exams KPI 390 is represented using a bar graph and associated numbers. The bars of the bar graph are colored to indicate scheduled exams versus completed exams. The bar provides a visual indication of a number of exams in relation to an y axis of a number of exams and an x axis of modality (e.g., CR, CT, MG, MR, NM, OT, US, XA, etc.). An alphanumeric indicator can also be displayed to provide an exact number of exams associated with the data point. Thus, a breakdown of pending versus completed exams can be provided by modality.

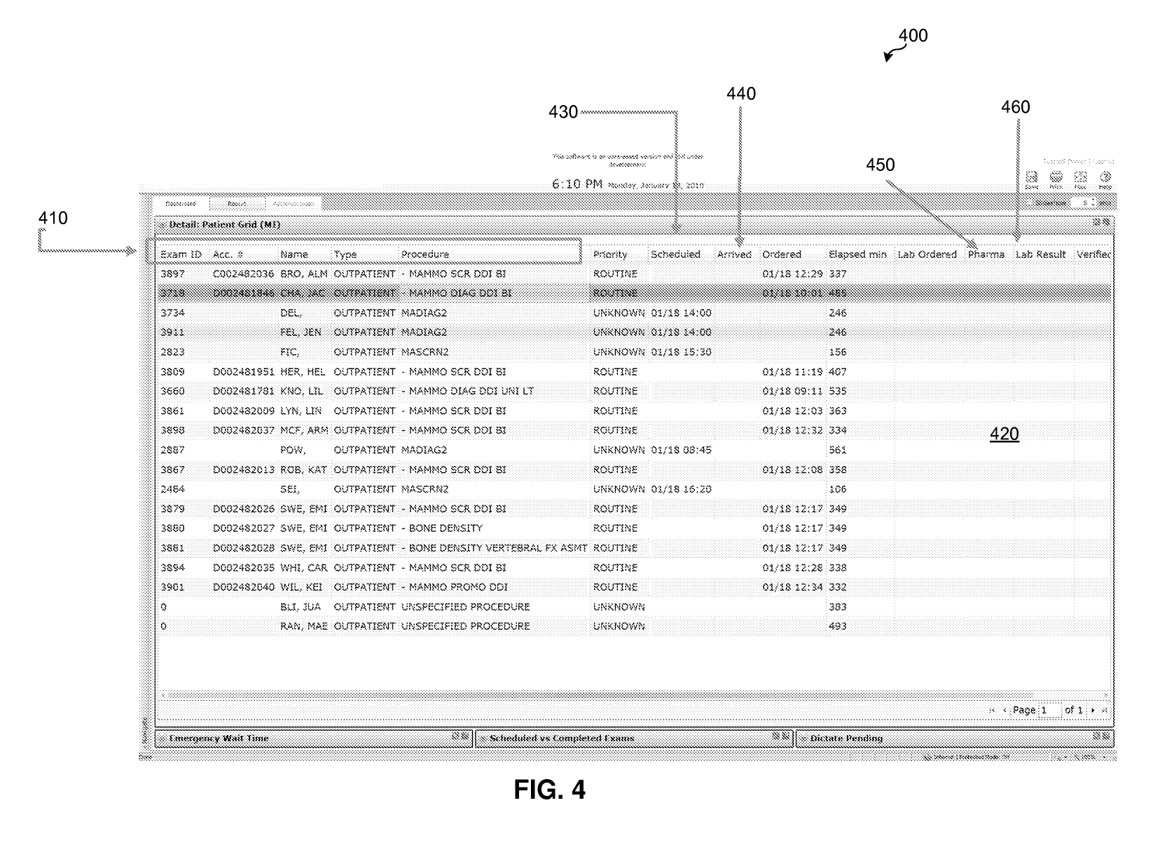

FIG. 4 depicts an example detail patient grid 400 providing patient information and worklist data for a clinician, department, and/or institution, etc. The patient grid 400 can be access via a tab control 410 and/or other option in the dashboard 400, for example. The patient grid 400 includes patient information 410 including exam identifier (ID), account number, name, type (e.g., outpatient, inpatient, emergency, etc.), procedure, priority, etc. The patient information 410 can include patient name and/or be anonymized depending upon user access and privacy rights. The patient information 410 can combine or separate inpatient, outpatient, and/or department (e.g., emergency department (ED)) patients in the view 400.

The patient grid 400 includes a data grid 420 associated with the patient information 410. The data grid 420 provides information and details timestamps indicating workflow state completion, for example. In certain examples, items in the data grid 420 can be selected (e.g., mouse/cursor click, mouseover, etc.) to display further information and/or associated functionality.

The grid 400 also displays a scheduled time 430 for a patient in the patient list. The schedule time 430 can include a link to access a scheduling interface, for example. The example grid 400 shows patient arrival, discharge, and/or transfer (ADT) information 440 as well. Other information such as procedure order date/time, lab order date/time, pharma information 450 (e.g., a contrast pull), lab results 460, verification information, etc., can be provided in the data grid 420.

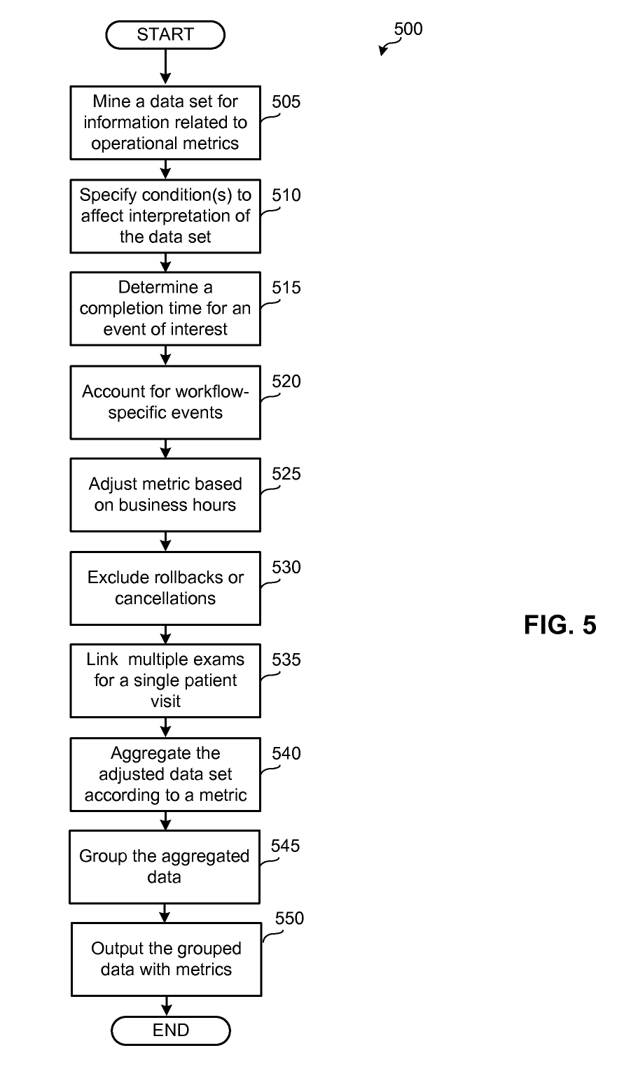

FIG. 5 depicts an example flow diagram representative of processes that can be implemented using, for example, computer readable instructions that can be used to facilitate collection of data, calculation of KPIs, and presentation for review of the KPIs. The example processes of FIG. 5 can be performed using a processor, a controller and/or any other suitable processing device. For example, the example processes of FIG. 5 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 5 can be implemented using coded instructions (e.g., computer readable instructions) stored on a non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 5 can be implemented manually or as any combination(s) of any of the foregoing techniques, for example, any combination of firmware, software, discrete logic and/or hardware. Further, although the example processes of FIG. 5 are described with reference to the flow diagram of FIG. 5, other methods of implementing the processes of FIG. 5 may be employed. For example, the order of execution of the blocks can be changed, and/or some of the blocks described may be changed, eliminated, sub-divided, or combined. Additionally, any or all of the example processes of FIG. 5 can be performed sequentially and/or in parallel by, for example, separate processing threads, processors, devices, discrete logic, circuits, etc.

FIG. 5 depicts a flow diagram for an example method 500 for computation and output of operational metrics for patient and exam workflow. At 505, an available data set is mined for information relevant to one or more operational metrics. For example, an operational data set obtained from multiple information sources, such as image modality and medical record archive data sources, are mined at both an exam and a patient visit level within a specified time range based on initial and final states of patient visit and exam workflow. This data set includes date and time stamps for events of interest in a hospital workflow along with exam and patient attributes specified by standards/protocols, such as HL7 and/or DICOM standards.

At 510, a user can specify one or more conditions to affect interpretation of the data in the data set. For example, the user can specify whether any or all states relevant to a workflow of interest have or have not been reached. For example, the user also has an ability to pass relevant filter(s) that are specific to a hospital workflow. A resulting data set is built dynamically based on the user conditions.

At 515, a completion time for an event of interest is determined by taking into account inherent or unavoidable delays in the workflow. For example, among events that bear a certain time stamp, certain events have different start and end times for which the end time may have not been communicated by any digital system. Thus, a completion time of that event can be determined for use in operational metrics computation.

As an example, patient preparation is a single event in patient workflow for which the start of event is communicated digitally but the end of event is not communicated. It becomes important to account for the time spent during that event and add it to a start event data time so that time spent in the activity is accounted for. The wait time can be computed with such deductions. For example, the patient was administered medicine for a nuclear CT with contrast procedure during patient preparation at 1:30 PM, and the CT scan was conducted at 2:00 PM. Based on this information, a tracking or timing system or associated metric should not show that patient is waiting idle for thirty (30) minutes if it takes thirty (30) minutes for the drug to take effect, for example.

At 520, institutional workflow specific events occurring during a single patient visit are accounted for with respect to an operational metrics computation. These events can include, for example, multiple exams in single patient visit, laboratory orders, pharmacy orders, patient transportation within a hospital, and/or other user defined hospital workflow events of interest. A search is then performed followed by a sort of results based on events of interest. The patient wait time between different events within single visit is computed.

At 525, a wait time is adjusted based on business hours of the healthcare institution. For example, if a hospital or clinic is not open or does not provide certain services during the night, the time associated with an unavailability of a service can be deducted from wait time computations.

At 530, if an exam and/or visit is rolled back or canceled, then data associated with the rollback or cancellation is excluded.

At 535, multiple exams during a single patient visit are linked based on visit identifier, date, and/or modality, for example. The patient is not counted multiple times for wait time calculation purposes. Additionally, all associated exams are not marked as dictated when an event associated with dictation of one of the exams is received.

At 540, a data set resulting from the adjustments above is aggregated according to a KPI. For example, if a final condition is not reached, a maximum time stamp is calculated for an initial condition and is deducted from the current time to determine the wait time. If a final condition is reached, the process calculates a maximum time stamp of an initial condition and a minimum time stamp for a final condition to calculate the elapse time.

At 545, once the above computations are completed, visits and exams are grouped according to one or more time threshold(s), as specified by one or more users in a hospital or other monitored healthcare enterprise. For example, an emergency department in a hospital wants to divide the patient wait times during visits into 0-15 minute, 15-30 minute, and over 30 minute wait time groups.

At 550, the grouped data is presented to a user. The data can be presented in the form of various graphical charts such as traffic lights, bar charts, and/or other graphical and/or alphanumeric indicators based on threshold(s), etc., in an operational metrics dashboard.

As described herein, the method 500 alternatively or in addition to being implemented for access via a workstation or other user computer, the method 500 can be implemented using a handheld and/or other mobile device in one or more combinations of hardware, software, and/or firmware, for example. The method 500 can operate in conjunction with one or more external systems (e.g., data sources, healthcare information systems (RIS, PACS, CVIS, HIS, etc.), archives, imaging modalities, etc.). One or more components of the method 500 can be reordered, eliminated, and/or repeated based on a particular implementation, for example.

In certain embodiments, mobile devices, such as but not limited to smart phones, ultra mobile and compact notebook computers, personal digital assistants, etc., offer many applications aside from phone functions. Certain embodiments allow clinical end users to enhance their collaboration with their colleagues, patients, and hospital enterprise via the mobile device.

By integrating enterprise functions for mobile devices, such as but not limited to a directory, calendar, geographic location, phone services, text messages, email services, etc., with clinical information from various clinical sources, such as but not limited to PACS, HIS, RIS, etc., end users can access patient centric information and enable real-time or substantially real-time collaboration with other end users to collaborate on a specific patient case. The collaboration allows information sharing and recording using multiple media services in real-time or substantially real-time.

In certain examples, a mobile (e.g., handheld) device allows a user to display and interact with medical content stored on one or more clinical systems via the mobile or handheld device (such as an iPad™, iPhone™, Blackberry™, etc.). A user can manipulate content, access different content, and collaborate with other users to analyze and report on exams and other medical content. In some examples, a change in device orientation and/or position results in a change in device mode and set of available tools without closing or losing the patient context and previous screen(s) of patient information. Images can be manipulated, annotated, highlighted, and measured via the device. Enterprise functionality and real-time collaboration are provided such that the user can collaborate on a document in real time with other users as well as access content from systems such as a RIS, PACS, EMR, etc., and make changes via the handheld device.

The handheld device can display and interact with medical content via a plurality of modes. Each mode includes different content and associated tools. Each of the plurality of modes is accessible based on a change in orientation and/or position of the device while maintaining a patient context across modes. The handheld device also includes medical content analysis capability for display, manipulation, and annotation of medical content and real-time sharing of the content for user collaboration using multi-touch control by the user. The handheld device communicates with one or more clinical systems to access and modify information from the one or more clinical systems in substantially real-time.

The handheld device can be used to facilitate user workflow. For example, the handheld device uses an accelerometer and/or global positioning sensor and/or other positional/motion indicator to allow a user to navigate through different screens of patient content and functionality. Using gestures, such as finger touching, pinching, swiping, etc., on or near the display surface can facilitate navigation through and viewing of image(s) in a large image dataset. In some examples, multi-touch capability is provided to manipulate and modify content. Via the handheld device, a user can input and/or manipulate without adding external input devices.

In certain examples, the handheld device provides enhance resetability for the user. For example, the device can undo, erase, and/or reset end user changes to default setting by tracking a device's position and/or orientation and responding to changes to the position/orientation. The device can undo and restart without additional user interface control input. The device can adjust a threshold parameter through user feedback, for example (e.g., a current setting may be too sensitive to normal movement of the device when carried or held by a user).

Certain examples integrate enterprise functions into a mobile device. For example, functionality such as a directory, calendar, geographic location, phone services, text message, email, etc., can be provided via the mobile device. Clinical information from various sources such as PACS, HIS, RIS, EMR, etc., can be provided via the mobile device. The mobile device interface can facilitate real-time collaboration with other end users. Information sharing and recording can be facilitated using multiple media services in real-time or substantially real-time, for example. The mobile device allows the user to focus on patient information and analysis while collaborating with one or more end users without switching or leaving the clinical context being reviewed, as well as exchanging medical data without losing the current state of the clinical context, for example. The mobile device provides a unified communication/collaboration point that can query and access information throughout different information systems, for example.

Certain examples facilitate user authentication via the mobile device. For example, the mobile device can authenticate a user's access to sensitive and/or private information. In certain embodiments, user authentication at the mobile device does not require the user to enter an identifier and password. Instead, the user is known, and the mobile device verifies if the current user is authorized for the particular content/application. Authentication is based on a unique identification number for the device, a connectivity parameter, and a PIN number for the user to enter, for example.

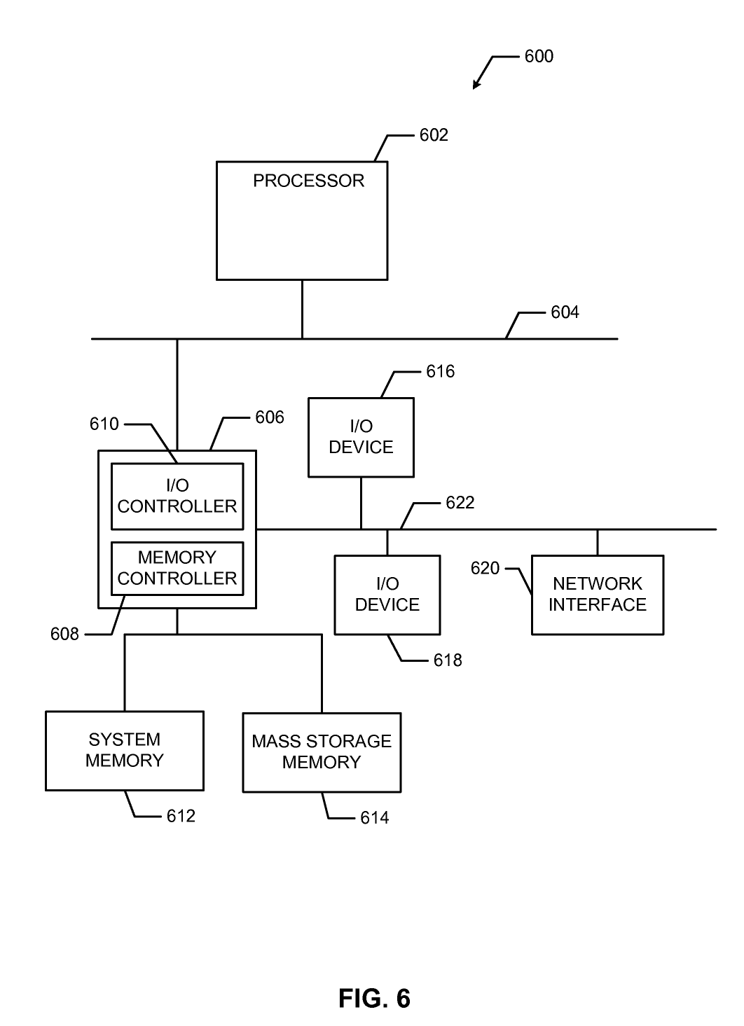

FIG. 6 is a block diagram of an example processor system 610 that may be used to implement the systems, apparatus and methods described herein. As shown in FIG. 6, the processor system 610 includes a processor 612 that is coupled to an interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Thus, certain examples provide more accurate determination of operational metrics, such as wait time, by accounting for workflow-specific delays, resource availability, cancellations, multiple events in a single visit, and user/institutional configuration. While prior techniques calculate patient wait time a by pre-defined set of events in normal workflow, if one of the events does not register into the system or a patient requires additional steps to prepare for a scanning protocol or other procedure, the patient wait time values calculated do not match actual patient wait time. A patient wait time calculation based only on a predefined set of two events (e.g., patient arrived, scan completed, etc.) has limitations on accuracy. Certain examples improve the accuracy of the patient wait time and turn-around time calculation in a healthcare departmental setting.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN), a wide area network (WAN), a wireless network, a cellular phone network, etc., that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method for generating operational metrics for a healthcare workflow, said method comprising:
mining a clinical data set including patient and exam workflow data according to an operational metric for a workflow of interest;
identifying one or more states involved in the workflow of interest;
determining a wait time for each of the one or more states;
applying one or more applicable deductions to the wait time for each of the one or more states based on one or more workflow-specific events to generate an adjusted wait time for each of the one or more states in the workflow of interest;
aggregating the adjusted wait time for each of the one or more states to generate a normalized wait time for the workflow of interest;
grouping normalized wait times for the workflow of interest according to one or more thresholds; and
outputting a representation of the normalized wait times based on the grouping and the one or more thresholds.

2. The method of claim 1, wherein the one or more thresholds comprise one or more wait time or turn-around time thresholds.

3. The method of claim 1, wherein the one or more applicable deductions comprise a business hours adjustment deduction.

4. The method of claim 1, wherein the one or more applicable deductions comprise a patient preparation time deduction.

5. The method of claim 1, wherein the one or more applicable deductions comprise a canceled or rollback workflow state deduction.

6. The method of claim 1, wherein the one or more applicable deductions comprise at least one of a deduction based on a multiple-day patient visit and a multiple-order patient visit.

7. The method of claim 1, further comprising filtering the clinical data set based one or more workflow dimensions.

8. The method of claim 7, wherein the one or more workflow dimensions comprise at least one of a procedure, a modality, a facility, a department, a clinician, a patient type, an admission type, and an order priority.

9. The method of claim 1, wherein a user is to specify whether each of the one or more states have been reached.

10. A tangible computer-readable storage medium having a set of instructions stored thereon which, when executed, instruct a processor to implement a method for generating operational metrics for a healthcare workflow, said method comprising:
mining a clinical data set including patient and exam workflow data according to an operational metric for a workflow of interest;
identifying one or more states involved in the workflow of interest;
determining a wait time for each of the one or more states;
applying one or more applicable deductions to the wait time for each of the one or more states based on one or more workflow-specific events to generate an adjusted wait time for each of the one or more states in the workflow of interest;
aggregating the adjusted wait time for each of the one or more states to generate a normalized wait time for the workflow of interest;
grouping normalized wait times for the workflow of interest according to one or more thresholds; and
outputting a representation of the normalized wait times based on the grouping and the one or more thresholds.

11. The computer-readable storage medium of claim 10, wherein the one or more thresholds comprise one or more wait time or turn-around time thresholds.

12. The computer-readable storage medium of claim 10, wherein the one or more applicable deductions comprise a business hours adjustment deduction.

13. The computer-readable storage medium of claim 10, wherein the one or more applicable deductions comprise a patient preparation time deduction.

14. The computer-readable storage medium of claim 10, wherein the one or more applicable deductions comprise a canceled or rollback workflow state deduction.

15. The computer-readable storage medium of claim 10, wherein the one or more applicable deductions comprise at least one of a deduction based on a multiple-day patient visit and a multiple-order patient visit.

16. The computer-readable storage medium of claim 10, further comprising filtering the clinical data set based one or more workflow dimensions.

17. The computer-readable storage medium of claim 16, wherein the one or more workflow dimensions comprise at least one of a procedure, a modality, a facility, a department, a clinician, a patient type, an admission type, and an order priority.

18. The computer-readable storage medium of claim 10, wherein a user is to specify whether each of the one or more states have been reached.

19. An operation metrics collection and processing system comprising:
a memory, a processor, and a user interface to display a dashboard including one or more performance indicators for review, wherein the processor executes instructions saved on the memory to:
mine a clinical data set including patient and exam workflow data from one or more information sources according to an operational metric for a workflow of interest;
identify one or more states involved in the workflow of interest;
determine a wait time for each of the one or more states;
apply one or more applicable deductions to the wait time for each of the one or more states based on one or more workflow-specific events to generate an adjusted wait time for each of the one or more states in the workflow of interest;
aggregate the adjusted wait time for each of the one or more states to generate a normalized wait time for the workflow of interest;
group normalized wait times for the workflow of interest according to one or more thresholds; and
output a representation of the normalized wait times to the user interface based on the grouping and the one or more thresholds.

20. The system of claim 19, further comprising a data interface to communicate and format data from the one or more information sources to form the clinical data set.

21. The system of claim 19, wherein the one or more thresholds comprise one or more wait time or turn-around time thresholds.

22. The system of claim 19, wherein the one or more applicable deductions comprise a business hours adjustment deduction.

23. The system of claim 19, wherein the one or more applicable deductions comprise a patient preparation time deduction.

24. The system of claim 19, wherein the one or more applicable deductions comprise a canceled or rollback workflow state deduction.

25. The system of claim 19, further comprising filtering the clinical data set based one or more workflow dimensions.

26. The system of claim 25, wherein the one or more workflow dimensions comprise at least one of a procedure, a modality, a facility, a department, a clinician, a patient type, an admission type, and an order priority.
